(19) United States
(12) Patent Application Publication
(10) Pub. No.: US 2015/0156364 A1
(43) Pub. Date: Jun. 4, 2015

(54) PRINT CONTROL APPARATUS, METHOD FOR CONTROLLING PRINT CONTROL APPARATUS, AND STORAGE MEDIUM

(71) Applicant: CANON KABUSHIKI KAISHA, Tokyo (JP)

(72) Inventor: Ryo Fujita, Kawasaki-shi (JP)

(21) Appl. No.: 14/555,255

(22) Filed: Nov. 26, 2014

(30) Foreign Application Priority Data
Nov. 29, 2013 (JP) 2013-246934

(51) Int. Cl. H04N 1/00; G06K 15/00

(52) U.S. Cl. CPC H04N 1/00896; G06K 15/4055; H04N 2201/0094

(57) ABSTRACT

A network transfer unit of a print control apparatus that is connected to an image forming apparatus to form a print system determines a power state of the print system based on an operating state of the print control apparatus and an operating state of the image forming apparatus, and then sends a notification of the determined power state over a network. In a case where there is a change in the operating state of the print control apparatus, the network transfer unit determines the operating state of the image forming apparatus without changing the operating state of the image forming apparatus, determines the power state of the print system based on the change in the operating state of the print control apparatus and the determined operating state of the image forming apparatus, and then sends a notification of the determined power state over the network.

### BACKGROUND

1. Technical Field

The present disclosure relates to a print system in which a print control apparatus and an image forming apparatus are connected to each other.

2. Description of the Related Art

An image forming apparatus for forming images, such as a multifunction peripheral (MFP) that serves as a copying machine, a printer, a scanner, and a facsimile is widely used. It is also common to establish a print system in which the image forming apparatus is connected to a print control apparatus which executes various types of image processing relating to print job processing, execute various types of setting processing on the image forming apparatus, and provide print commands to the image forming apparatus. The print control apparatus is called a digital front end (DFE), and has various functions just like the image forming apparatus.

Generally, the MFP or the DFE can be connected to a network and has a function of sending and receiving data to and from a computer over the network, e.g., a function of receiving print job data and sending scanned data. Examples of the case where the MFP or the DFE sends and receives data to and from a computer on a network include a case where various applications such as a printer driver and printing apparatus management software are operated on the computer on the network. Examples of the case also include a case where the user uses a function of the MFP or the DFE to send scanned data or receive job data from a server over the network.

To reduce power consumption, it is also common for such an apparatus to have a function of shifting to a sleep state in which the power consumption is lower than that in a normal standby state. In this case, the apparatus typically has a configuration in which the apparatus shifts to the sleep state if the apparatus has not been used for a certain period of time or if the user gives a sleep instruction, and recovers to the normal standby state if the apparatus is forced to be operated to execute job print or the like.

In some cases, it is desirable to send a notification of the operating state of the apparatus to the computer on the network or to allow the computer on the network to acquire information about the operating state of the apparatus when the operating state of the apparatus is changed. For example, it may be desired to stop network inquiries from the computer when the apparatus shifts to the sleep state, and to resume the network inquiries when the apparatus recovers to the normal standby state so that unnecessary inquiries are restrained to maintain the sleep state longer. In such a case, the notification or acquisition of the operating state information is effective.

Japanese Patent No. 4,440,326 discusses a technique by which an image forming apparatus includes two response units configured to respond to an inquiry about the status of the image forming apparatus. The image forming apparatus switches from the normal response unit to the response unit having lower power consumption when the image forming apparatus shifts to the sleep state, whereas the image forming apparatus switches from the response unit having lower power consumption to the normal response unit when the image forming apparatus recovers from the sleep state. Use of the technique enables acquisition of the operating state information of the image forming apparatus from a computer on a network even when the image forming apparatus is in the sleep state.

Further, according to the technique discussed in Japanese Patent No. 4,440,326, a notification of a change in the operating state of the apparatus can be easily sent to the computer by sending multicast packets or broadcast packets over the network at the same timing as the switching of the response unit. In this way, the computer on the network can acquire the operating state information of the apparatus without making an inquiry.

However, the above-described conventional technique causes the following problem at the time of sending a notification of the operating state of the print system in which the MFP and the DFE are connected to each other. According to the above-described conventional technique, based on a change in the operating state of the MFP itself, the MFP switches the response unit and sends a notification of the change in the operating state of the MFP. The notification function similar to that of the MFP may also be applied to the DFE. However, in the print system in which the MFP and the DFE are connected to each other, if each of the apparatuses individually sends a notification of a change in the operating state based on the operating state of the apparatus itself, the notification may not be performed appropriately.

For example, in a case where the MFP and the DFE are both in the sleep state in view of energy saving and then only the DFE recovers to the normal standby state, it is desirable to maintain the operating state of the print system in the sleep state in view of energy saving. However, in this case, the notification cannot be appropriately performed. According to the conventional technique, the DFE notifies the network that it has recovered to the normal standby state. As a result, a computer on the network having received this notification resumes accessing the print system to cause unnecessary recovery of the MFP. Further, according to the conventional technique, there are cases where the same notification is redundantly sent from the MFP and the DFE, and where different notifications are sent depending on the path of the state transition although the print system shifts to the same state.

The print system in which the MFP and the DFE are connected to each other also has the following problem. When the operating state of the DFE is changed, even though the DFE intends to send a notification of the change based on the operating state of the MFP, since the operating state of the MFP is unknown at that time, it is not possible for the DFE to send an accurate notification. One example is a case where the MFP and the DFE both have the function of shifting to the sleep state and the DFE does not always shift to the normal standby state in view of energy saving when the MFP shifts to the normal standby state. In this case, the operating state of the MFP may be changed while the DFE is in the sleep state. However, since the DFE minimizes control processing during the sleep state to reduce power consumption, the DFE may not be able to detect the change in the operating state of the MFP. Therefore, when the DFE recovers from the sleep state, the DFE may not be able to send an accurate notification of the operating state of the print system.

Accordingly, in some cases, the conventional technique for sending a notification of the operating state of the print system in which the DFE and the MFP are connected to each other is not desirable in view of energy saving.

### SUMMARY

The present disclosure is directed to a technique that can appropriately send a notification of an operating state of a print system in which a DFE and a MFP are connected to each other.

According to an aspect of the present invention, a print control apparatus in a print system including the print control apparatus and an image forming apparatus, in which the print control apparatus is connected to a network and operates by switching between at least a first operating state and a second operating state lower in power consumption than the first operating state, and the image forming apparatus is connected to the print control apparatus and operates by switching between at least a third operating state and a fourth operating state lower in power consumption than the third operating state, includes a notification unit configured to determine a power state of the print system based on an operating state of the print control apparatus and an operating state of the image forming apparatus, and then send a notification of the determined power state over the network. Further, in a case where there is a change in the operating state of the print control apparatus, the notification unit determines the operating state of the image forming apparatus, determines the power state of the print system based on the change in the operating state of the print control apparatus and the determined operating state of the image forming apparatus, and then sends a notification of the determined power state over the network.

Further features of the present invention will become apparent from the following description of exemplary embodiments with reference to the attached drawings.

### BRIEF DESCRIPTION OF THE DRAWINGS

FIG. 1 illustrates an example of a configuration of a print system according to an exemplary embodiment of the present invention.

FIG. 2 illustrates an example of a hardware configuration of a print control apparatus.

FIG. 3 illustrates an example of a hardware configuration of an image forming apparatus.

FIG. 4 illustrates an example of a software configuration of a print control apparatus and an image forming apparatus.

FIG. 5 is a flowchart illustrating an example of a proxy response operation performed by an image forming apparatus.

FIG. 6 is a flowchart illustrating an example of an operation to send a notification of an operating state of a print control apparatus.

FIG. 7 is a flowchart illustrating an example of processing for determining a power state of an image forming apparatus by a print control apparatus according to a first exemplary embodiment.

FIG. 8 is a flowchart illustrating an example of processing for determining a power state of an image forming apparatus by a print control apparatus according to a second exemplary embodiment.

FIG. 9 is a flowchart illustrating an example of processing for determining a power state of an image forming apparatus by a print control apparatus according to a third exemplary embodiment.

FIG. 10 is a state transition diagram illustrating operating state transitions of a print control apparatus and an image forming apparatus.

### DESCRIPTION OF THE EMBODIMENTS

Various exemplary embodiments, features, and aspects of the invention will be described in detail below with reference to the drawings.

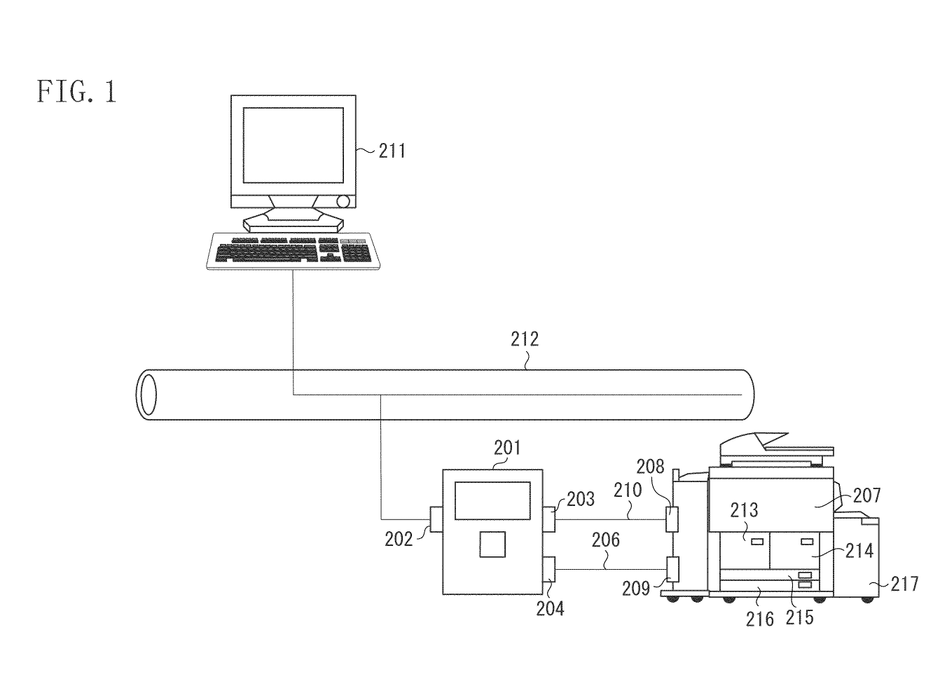

The following describes the basic operations of a print system including a print control apparatus and an image forming apparatus, with reference to FIGS. 1, 2, and 3.

FIG. 1 illustrates an example of a configuration of a print system according to an exemplary embodiment of the present invention.

As illustrated in FIG. 1, a print control apparatus 201 is an external controller of an image forming apparatus 207. The print control apparatus 201 and the image forming apparatus 207 are connected to each other via a network cable 210 and a dedicated transmission line 206. Connectors 203 and 208 are used for connecting the print control apparatus 201 and the image forming apparatus 207 to the network cable 210, respectively. Connectors 204 and 209 are used for connecting the print control apparatus 201 and the image forming apparatus 207 to the dedicated transmission line 206, respectively.

The print control apparatus 201 executes image processing (e.g., raster image processor (RIP) processing to be described below) for a print job received from an external device, and inputs the print job, for which the image processing has been executed, to the image forming apparatus 207. The image forming apparatus 207 is combined with the print control apparatus 201 to form one print system. The image forming apparatus 207 includes sheet feeding devices 213 and 217, and executes print processing on a recording sheet fed from the sheet feeding device 213 or 217.

A print terminal 211 is an information processing apparatus (e.g., personal computer) connected to a local area network (LAN) 212. The print terminal 211 can send a print job via the LAN 212 to the print system including the print control apparatus 201 and the image forming apparatus 207. In other words, a print job is sent from the print terminal 211 to the print control apparatus 201.

The LAN 212 is a network to which the print control apparatus 201 and the print terminal 211 are connected. The LAN 212 realizes a LAN connection such as Ethernet (registered trademark). A connector 202 is used for connecting the print control apparatus 201 to the LAN 212.

The network cable 210 is used to connect the print control apparatus 201 and the image forming apparatus 207 to each other. The network cable 210 realizes a LAN connection such as Ethernet (registered trademark) between the print control apparatus 201 and the image forming apparatus 207. The dedicated transmission line 206 is a dedicated transmission line for sending image data from the print control apparatus 201 to the image forming apparatus 207.

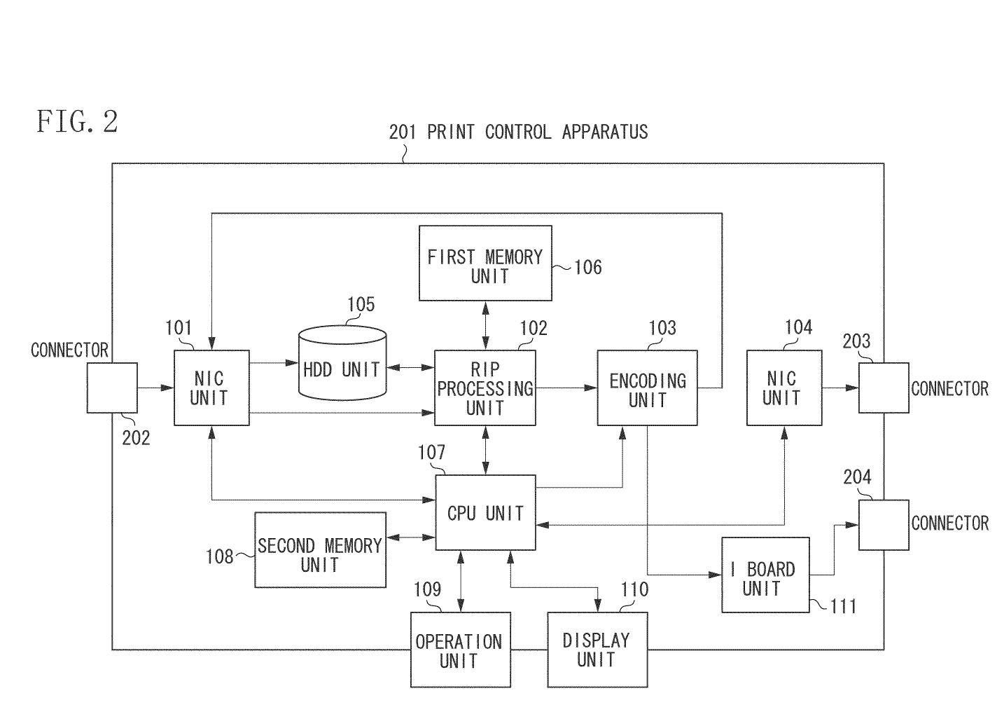

FIG. 2 is a block diagram illustrating an example of a hardware configuration of the print control apparatus 201.

In FIG. 2, a network interface card (NIC) unit 101 is a first network interface for controlling low-layer level connection to the LAN 212 illustrated in FIG. 1.

A hard disk drive (HDD) unit 105 temporarily stores print data received by the NIC unit 101 or RIP-processed data to be described below. The HDD unit 105 also stores various types of setting value information managed by the print control apparatus 201, and the print control apparatus 201 can read the setting value information from the HDD unit 105 to use it as needed and also can write a change to the setting value information thereto. Any other storage device such as a solid state drive (SSD) may be used in place of the HDD.

A RIP processing unit 102 rasterizes the data that is received by the NIC unit 101 and written in a print language such as a page description language (PDL). A first memory unit 106 is a memory used by the RIP processing unit 102 in the image rasterization processing. An encoding unit 103 converts the data rasterized by the RIP processing unit 102 into print data or a data format supported by the image forming apparatus 207.

A central processing unit (CPU) unit 107 controls the entire part of the print control apparatus 201. A second memory unit 108 is used as a temporary data storage area by the CPU unit 107. An operation unit 109 includes buttons, keys, a touch panel integrated with a display unit 110, etc. The operation unit 109 and the display unit 110 are used to operate the print control apparatus 201.

A NIC unit 104 is a second network interface for controlling low-layer level connection. An image interface board unit (I board unit) 111 is an interface for outputting the data obtained by the encoding unit 103 to the image forming apparatus 207 via the dedicated transmission line 206.

When the print terminal 211 inputs a print job to the print control apparatus 201, data packets are transmitted from the print terminal 211 to the print control apparatus 201 through the LAN 212 and then loaded into the print control apparatus 201 via the connector 202. In the print control apparatus 201, the NIC unit 101 executes data reception processing. When the print control apparatus 201 receives the print data, the received data is written to the HDD unit 105 as necessary according to the control of the CPU unit 107. This is the queueing (spooling) that is generally performed to increase the data transfer speed and the like. The data stored in the HDD unit 105 is read by the RIP processing unit 102 according to an instruction from the CPU unit 107. On the other hand, print data on which no queueing is performed is transferred directly to the RIP processing unit 102 according to an instruction from the CPU unit 107.

The print data thus sent to the RIP processing unit 102 is rasterized by the RIP processing unit 102. The data rasterized by the RIP processing unit 102 is then encoded to a data format that is interpretable by the image forming apparatus 207 based on a data format preset in the encoding unit 103 and interpretable by the image forming apparatus 207 and on the format of the received data. This encoding processing is executed as needed and may be skipped if the encoding is not necessary, for example, in a case where the format of the received print data is directly interpretable by the image forming apparatus 207. The encoded data needs to be in a format that is interpretable by the image forming apparatus 207, and the format varies depending on the capacity of an interpretation unit included in the image forming apparatus 207, such as a specific print language format or a data format compressed by a specific method such as the Joint Bi-level Image Experts Group (JBIG) standard.

The image data obtained by the encoding unit 103 is transferred to the image interface board unit 111, transmitted through the dedicated transmission line 206 via the connector 204, and sent to the image forming apparatus 207 via the connector 209. Data other than image data, such as a control command, is converted into data packets again by the NIC unit 104 to send the data to the network cable 210, and the data packets are output from the connector 203 and sent to the image forming apparatus 207 via the network cable 210 and the connector 208. When the image forming apparatus 207 receives the data from the print control apparatus 201, the image forming apparatus 207 executes print processing on a sheet fed from the sheet feeding device 213 or 217 according to a print processing procedure of the image forming apparatus 207.

While the present exemplary embodiment describes the configuration in which the print control apparatus 201 and the image forming apparatus 207 communicate with each other via the network cable 210 and the dedicated transmission line 206, the print control apparatus 201 and the image forming apparatus 207 may communicate with each other only via the network cable 210. In this case, image data, and data other than image data such as a control command are both sent or received via the network cable 210.

The print control apparatus 201 can shift at least to a normal standby state or a sleep state (also referred to as “sleep mode” or “power-saving state”). The sleep state has lower power consumption than that in the normal standby state. In a case where the print control apparatus 201 shifts to the sleep state, in order to reduce the power consumption, the print control apparatus 201 supplies power from a power-supply unit (not illustrated) only to a minimum number of blocks that are needed to maintain the sleep state or recover to the normal standby state, and the other blocks are controlled to stop processing to reduce the supply of power. For example, in the sleep state, the print control apparatus 201 executes power supply control in such a way that the supply of power to blocks other than the NIC units 101 and 104 and the second memory unit 108 is stopped. Alternatively, in the sleep state, the power may be supplied to the CPU unit 107. On the other hand, in the normal standby state, the power may be supplied to every block of the print control apparatus 201, or the supply of power may partially be stopped as needed.

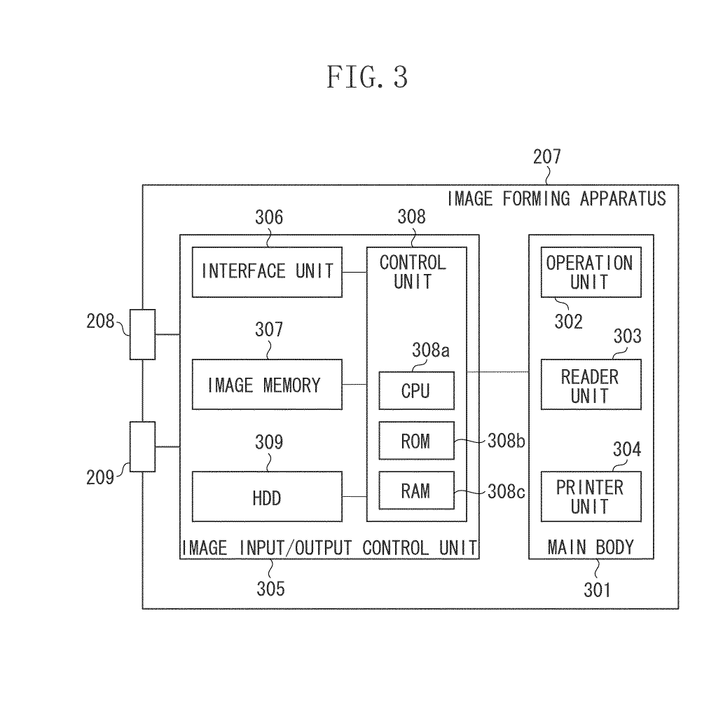

FIG. 3 is a block diagram illustrating an example of a hardware configuration of the image forming apparatus 207.

As illustrated in FIG. 3, the image forming apparatus 207 according to the present exemplary embodiment includes a main body 301 of the image forming apparatus 207 and an image input/output control unit 305.

The main body 301 includes an operation unit 302, a reader unit 303, and a printer unit 304. The operation unit 302 is used to operate the main body 301 and the image input/output control unit 305. The reader unit 303 reads a document image and outputs image data corresponding to the document image to the printer unit 304 and the image input/output control unit 305. The printer unit 304 records on a recording sheet an image corresponding to the image data sent from the reader unit 303 and the image input/output control unit 305.

The image input/output control unit 305 is connected to the main body 301 and includes an interface unit 306, an image memory 307, a control unit 308, and a HDD 309. The HDD 309 stores the settings of the image forming apparatus 207. The settings include, for example, address book, operation history, user settings, identification (ID) settings, network settings, and the like.

The interface unit 306 is an interface between the print control apparatus 201 and the control unit 308. The interface unit 306 includes an image interface unit (not illustrated) and a network interface unit (not illustrated).

The image interface unit of the interface unit 306 receives, via the connector 209, code data representing an image transferred from the print control apparatus 201, decompresses the received data to image data that is recordable by the printer unit 304, and passes the image data to the control unit 308. The network interface unit of the interface unit 306 receives, via the connector 208, code data representing a control command or the like transferred from the print control apparatus 201 and passes the received data to the control unit 308.

In a case where the image forming apparatus 207 is directly connected to the LAN 212, the network interface unit of the interface unit 306 is an interface between the print terminal 211 on the network 212 and the control unit 308. In this case, the network interface unit of the interface unit 306 receives, via the connector 208, code data representing image data transferred from the print terminal 211. The network interface unit of the interface unit 306 decompresses, if necessary, the received data into data that is recordable by the printer unit 304 and then passes the data to the control unit 308.

Alternatively, the dedicated transmission line 206 may be omitted, and the print control apparatus 201 and the image forming apparatus 207 may communicate with each other via the network cable 210. Alternatively, the connectors 208 and 209 may be a parallel interface or an interface such as a universal serial bus (USB) interface, and the print control apparatus 201 and the image forming apparatus 207 may be connected to each other via that interface cable. The interface cable is not limited to a single cable, and multiple cables may be used.

The control unit 308 includes a CPU 308a, a read-only memory (ROM) 308b, and a random-access memory (RAM) 308c. In the control unit 308, the CPU 308a loads into the RAM 308c a program stored in the ROM 308b or another storage medium, and executes the program to control the flow of data between the reader unit 303, the interface unit 306, the image memory 307, etc. The ROM 308b includes, for example, a flash ROM. Alternatively, a non-volatile storage device (e.g., SSD) that retains data even if a power supply is disconnected may be provided in place of the HDD 309 to store data in the non-volatile storage device.

The image forming apparatus 207 can shift at least to a normal standby state or a sleep state (also referred to as “sleep mode” or “power-saving state”). The sleep state has lower power consumption that that in the normal standby state. In a case where the image forming apparatus 207 shifts to the sleep state, in order to reduce the power consumption, the image forming apparatus 207 supplies power from a power-supply unit (not illustrated) only to a minimum number of blocks that are needed to maintain the sleep state or recover to the normal standby state, and the other blocks are controlled to stop processing to reduce the supply of power. For example, in the sleep state, the image forming apparatus 207 executes power supply control in such a way that while the supply of power to the printer unit 304 and the HDD 309 is stopped, the supply of power to the interface unit 306, the control unit 308, and the operation unit 302 is partially continued. Alternatively, in the sleep state, the supply of power to the entire part of the control unit 308 may be maintained, or the supply of power to the CPU 308a and the ROM 308b may be stopped while the supply of power to the RAM 308c is continued. On the other hand, in the normal standby state, the power may be supplied to every block of the image forming apparatus 207, or the supply of power may partially be stopped as needed.

The sheet feeding devices 213 and 217 of the image forming apparatus 207 illustrated in FIG. 1 are divided into two categories according to how the sheet feeding device is opened to replenish sheets. One category is an electronic lock type sheet feeding device that is opened by unlocking the electronic lock. When the image forming apparatus 207 is in the sleep state, the operation thereof is stopped except for a part of the control unit 308, the interface unit 306, and the operation unit 302. Thus, to set a sheet in the electronic lock type sheet feeding device, first, an activation instruction is provided from the operation unit 302 or the print control apparatus 201 to the image forming apparatus 207. Then, after the image forming apparatus 207 recovers from the sleep state to the normal standby state, a button provided to the sheet feeding device 213 or 217 needs to be pressed. The other category is a non-electronic lock type sheet feeding device. Even when the image forming apparatus 207 is in the sleep state, the non-electronic lock type sheet feeding device can be opened at the press of the button provided to the sheet feeding device 213 or 217 without causing the image forming apparatus 207 to recover to the normal standby state.

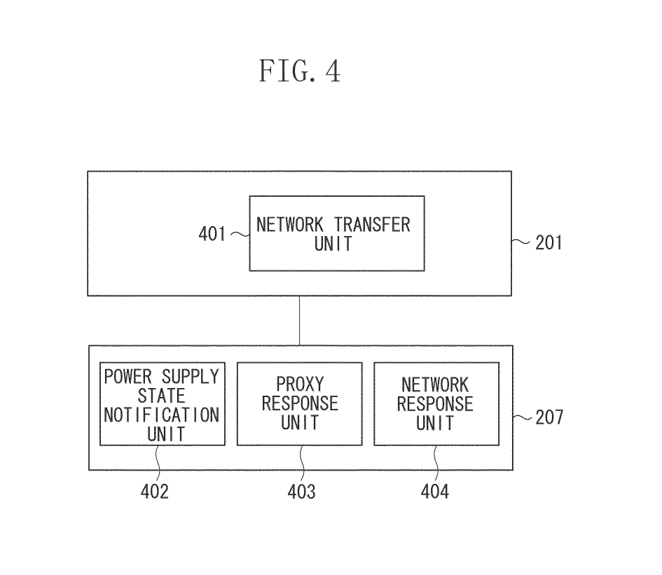

The following describes a software configuration of the print control apparatus 201 and the image forming apparatus 207 with reference to FIG. 4.

FIG. 4 illustrates an example of the software configuration of the print control apparatus 201 and the image forming apparatus 207.

A network transfer unit 401 is a part of processing functions realized by the CPU unit 107 of the print control apparatus 201, which loads a program stored in the HDD unit 105 or the like into the second memory unit 108 and then executing the program. A power supply state notification unit 402, a proxy response unit 403, and a network response unit 404 are a part of the processing functions realized by the CPU 308a of the control unit 308 of the image forming apparatus 207, which executes a program stored in the ROM 308b.

The proxy response unit 403 and the network response unit 404 of the image forming apparatus 207 both have a function to respond to a network inquiry received by the connector 208. Examples of the network inquiry to the image forming apparatus 207 include an inquiry for acquiring data of a management information base (MIB) that specifies the state of a device of the image forming apparatus 207, and a network session initiation request with respect to the image forming apparatus 207.

When the image forming apparatus 207 is in the normal standby state, such network inquiries are all transmitted through the proxy response unit 403 and received by the network response unit 404. The network response unit 404 determines whether to send a response and determines a content of the response based on the internal state of a device and setting item values. In other words, when the image forming apparatus 207 is in the normal standby state, the proxy response unit 403 does not function.

The following describes the processing executed when the image forming apparatus 207 is in the sleep state. As described above, in the sleep state, in order to reduce the power consumption, the image forming apparatus 207 supplies power only to a minimum number of blocks that are needed to maintain the sleep state or recover to the normal standby state among the blocks illustrated in FIG. 3, and the other blocks are controlled to stop processing to reduce the supply of power. For example, in a case where the reading and writing of data and the print processing are not executed in the sleep state, the supply of power to the printer unit 304 and the HDD 309 is stopped, while the supply of power to the control unit 308 and the interface unit 306 is continued. The proxy response unit 403 realized by the control unit 308 and the interface unit 306 continues the network inquiry control processing even when the image forming apparatus 207 is in the sleep state, and the proxy response unit 403 executes processing for responding to a network inquiry and processing for recovering to the normal standby state during the sleep state. In a case where the image forming apparatus 207 is configured to stop the supply of power to the CPU 308a and the ROM 308b of the control unit 308 while in the sleep state, the interface unit 306 may implement the proxy response unit 403. When the image forming apparatus 207 is in the sleep state, the network response unit 404 does not function.

The following describes the power supply state notification unit 402. When the image forming apparatus 207 shifts to the sleep state, the power supply state notification unit 402 notifies the print control apparatus 201 of the “sleep” state as the state of the image forming apparatus 207. When the image forming apparatus 207 recovers from the sleep state to the normal standby state, the power supply state notification unit 402 notifies the print control apparatus 201 of the “normal standby” state as the state of the image forming apparatus 207.

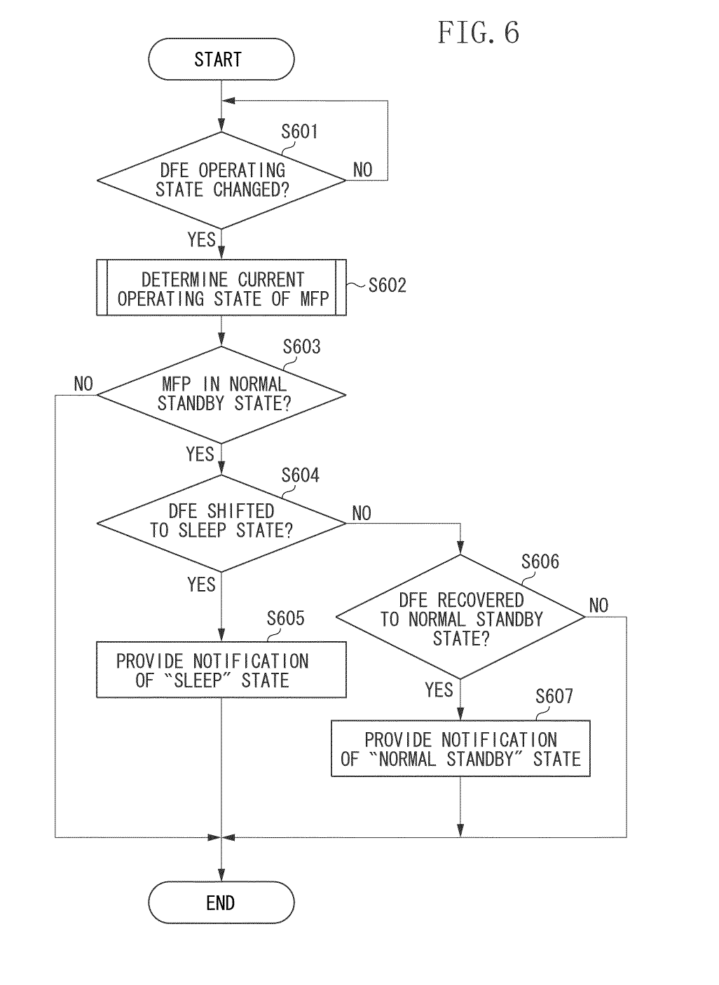

When the network transfer unit 401 of the print control apparatus 201 receives a notification sent from the power supply state notification unit 402, the network transfer unit 401 transfers the notification over the network 212 as a notification of the operating state of the print system. When the print control apparatus 201 is in the sleep state, the print control apparatus 201 discards the notification and does not transfer the notification over the network 212. When the operating state of the print control apparatus 201 is changed, the network transfer unit 401 sends a notification of the operating state of the print system over the network 212 (details are illustrated in FIG. 6 to be described below).

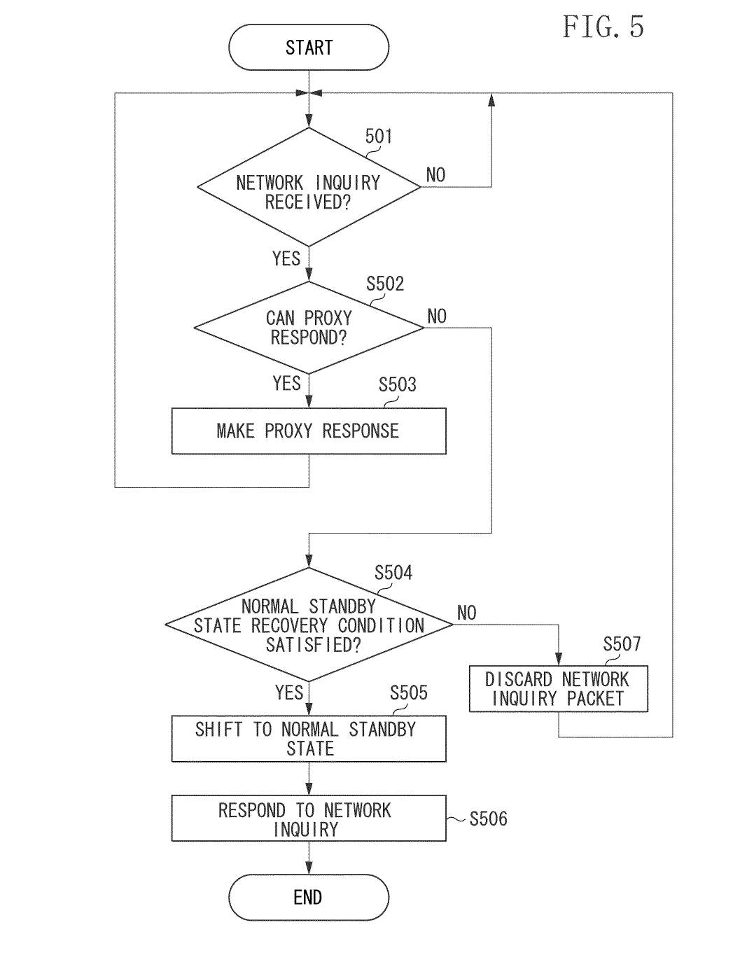

The following describes a proxy response function of the image forming apparatus 207 with reference to FIG. 5.

FIG. 5 is a flowchart illustrating an example of the proxy response operation performed by the image forming apparatus 207. The CPU 308a of the control unit 308 of the image forming apparatus 207 executes a program stored in the ROM 308b to realize the processing illustrated in the flowchart. The processing illustrated in the flowchart is started when the image forming apparatus 207 has shifted to the sleep state. In a case where the image forming apparatus 207 is configured to stop the supply of power to the CPU 308a and the ROM 308b of the control unit 308 while in the sleep state, the interface unit 306 implements the processing executed by the proxy response unit 403 in the flowchart.

In step S501, the proxy response unit 403 monitors whether a network inquiry is received via the connector 208. If the proxy response unit 403 determines that no network inquiry is received (NO in step S501), the proxy response unit 403 repeats the processing in step S501. On the other hand, if the proxy response unit 403 determines that a network inquiry is received (YES in step S501), the processing proceeds to step S502.

In step S502, the proxy response unit 403 determines whether the received network inquiry is an inquiry to which a proxy can respond. As used herein, “an inquiry to which a proxy can respond” refers to an inquiry that matches a network inquiry pattern registered in advance in the proxy response unit 403. In the present exemplary embodiment, since the connector 208 is a network interface connector, “an inquiry to which a proxy can respond” refers to an inquiry that matches a network packet pattern registered in advance in the proxy response unit 403. As described above, since the supply of power to the HDD 309 is stopped when the image forming apparatus 207 shifts to the sleep state, not all the device states and setting item values stored in the image forming apparatus 207 are accessible to the proxy response unit 403. Thus, a packet pattern to which a proxy can respond is registered in advance in the proxy response unit 403 to create a state where a response to a specific inquiry can be made without resuming the supply of power to the HDD 309, whereby the recovery to the normal standby state is minimized so that the power consumption can be reduced.

In step S502, if the proxy response unit 403 determines that the received network inquiry is an inquiry to which a proxy can respond (YES in step S502), the proxy response unit 403 responds to the network inquiry. Then, the processing proceeds to step S501 without causing the image forming apparatus 207 to recover to the normal standby state.

On the other hand, if the proxy response unit 403 determines that the received network inquiry is not an inquiry to which a proxy can respond (NO in step S502), the processing proceeds to step S504. In step S504, the proxy response unit 403 determines whether the network inquiry satisfies a normal standby state recovery condition. An inquiry packet pattern that requires the recovery to the normal standby state is also registered in advance in the proxy response unit 403 as in the case of the inquiry to which a proxy can respond. A packet pattern to be discarded may also be registered in the proxy response unit 403. The packet pattern to which a proxy can respond, the inquiry pattern that requires the recovery to the normal standby state, and the packet pattern to be discarded are stored in, for example, the flash ROM 308b.

If the proxy response unit 403 determines that the network inquiry does not satisfy a normal standby state recovery condition (NO in step S504), then in step S507, the proxy response unit 403 discards the network inquiry packet, and the processing proceeds to step S501. That is to say, in this case, the image forming apparatus 207 neither responds to the network inquiry nor recovers to the normal standby state. Examples of such a network inquiry include a broadcast packet using a protocol that is not registered in advance in the proxy response unit 403.

On the other hand, in step S504, if the proxy response unit 403 determines that the network inquiry satisfies a normal standby state recovery condition (YES in step S504), then in step S505, the proxy response unit 403 shifts the image forming apparatus 207 to the normal standby state. As a result, the network response unit 404 becomes operable. In step S506, the network response unit 404 responds to the network inquiry. Examples of the network inquiry that requires the recovery to the normal standby state include a network session initiation request with respect to a network port via which the image forming apparatus 207 receives print job data.

The following describes an operating state notification method executed by the print control apparatus 201 and the image forming apparatus 207 with reference to FIGS. 6, 7, and 10. The present exemplary embodiment will describe a method in which a notification of the operating state of the print system is sent to the computer (print terminal 211) on the network when the operating state of the print control apparatus 201 is changed. The CPU unit 107 executes a program stored in the HDD unit 105 or the like to realize the processing of the print control apparatus 201 to be described below. Further, the CPU 308a of the control unit 308 executes a program stored in the ROM 308b to realize the processing of the image forming apparatus 207 to be described below.

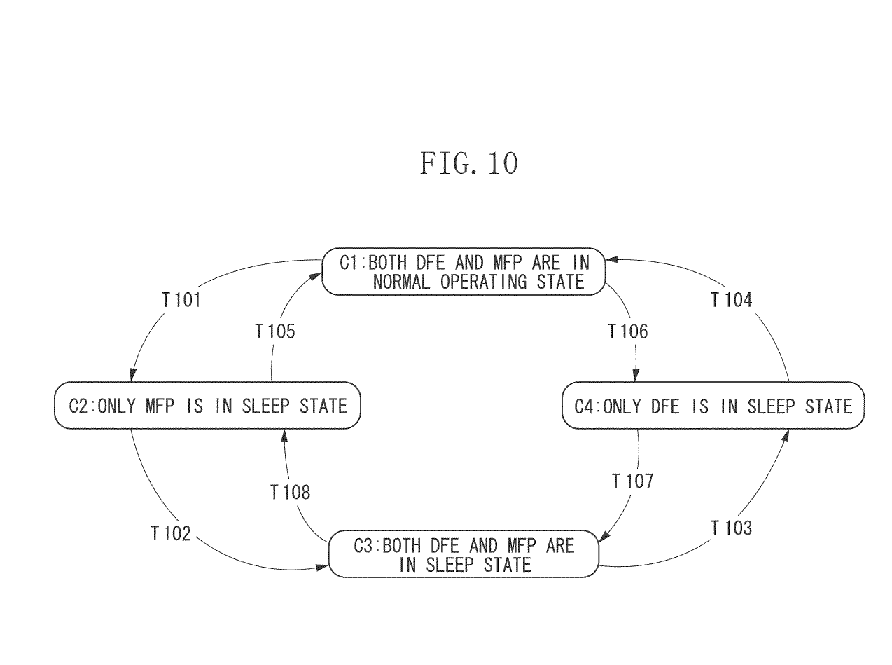

FIG. 10 is a state transition diagram illustrating an example of changes in the combination of the operating states of the print control apparatus 201 and the image forming apparatus 207.

A state C1 is a state of the print system in which the print control apparatus 201 and the image forming apparatus 207 are both in the normal operating state. A state C2 is a state of the print system in which the print control apparatus 201 is in the normal operating state and only the image forming apparatus 207 is in the sleep state. A state C4 is a state of the print system in which only the print control apparatus 201 is in the sleep state and the image forming apparatus 207 is in the normal operating state. A state C3 is a state of the print system in which the print control apparatus 201 and the image forming apparatus 207 are both in the sleep state.

The print system can shift between the states C1 and C2 (T101, T105). More specifically, when the print system is in the state C1, if only the image forming apparatus 207 shifts to the sleep state, the print system shifts from the state C1 to C2 (T101). On the other hand, when the print system is in the state C2, if the image forming apparatus 207 recovers to the normal operating state, the print system shifts from the state C2 to C1 (T105).

Similarly, the print system can shift between the states C2 and C3 (T102, T108). Further, the print system can shift between the states C3 and C4 (T103, T107). Furthermore, the print system can shift between the states C4 and C1 (T104, T106).

In the present exemplary embodiment, when the print system shifts from the state C1 to C3 or from the state C3 to C1, the print system shifts via the state C2 or C4 and does not shift directly between the states C1 and C3. Similarly, when the print system shifts from the state C2 to C4 or from the state C4 to C2, the print system shifts via the state C1 or C3 and does not shift directly between the states C2 and C4.

When the operating state of the image forming apparatus 207 is changed, the power supply state notification unit 402 of the image forming apparatus 207 notifies the print control apparatus 201 of the operating state. That is to say, the power supply state notification unit 402 sends a notification of the operating state to the print control apparatus 201 according to the four state transitions, the transition from the state C1 to C2 (T101), the transition from the state C2 to C1 (T105), the transition from the state C3 to C4 (T103), and the transition from the state C4 to C3 (T107). In the case of the transition T101, the power supply state notification unit 402 sends a notification of the “sleep” state. In the case of the transition T105, the power supply state notification unit 402 sends a notification of the “normal standby” state. The notification of the transition T101 or T105 is transferred as a notification of the operating state of the print system over the network 212 by the network transfer unit 401 of the print control apparatus 201. Further, in the case of the transition T103, the power supply state notification unit 402 sends a notification of the “normal standby” state. In the case of the transition T107, the power supply state notification unit 402 sends a notification of the “sleep” state. However, since the print control apparatus 201 is in the sleep state, the notification of the transition T103 or T107 is discarded by the print control apparatus 201 and is not transferred over the network 212.

The following describes the operating state notification operation performed when the operating state of the print control apparatus 201 is changed, with reference to FIG. 6. More specifically, the following describes how a notification of the operating state is sent according to the four state transitions, the transition from the state C1 to C4 (T106), the transition from the state C4 to C1 (T104), the transition from the state C2 to C3 (T102), and the transition from the state C3 to C2 (T108), with reference to FIG. 6.

FIG. 6 is a flowchart illustrating an example of the operation to send a notification of the operating state of the print control apparatus 201. The CPU unit 107 executes a program stored in the HDD unit 105 or the like to realize the processing illustrated in the flowchart. The flowchart is started when the network transfer unit 401 starts monitoring the operating state of the print control apparatus 201. The timing of starting the flowchart is when the processing goes to the network transfer unit 401, e.g., when the print control apparatus 201 is turned on or when the operating state of the print control apparatus 201 shifts from the sleep state to the normal standby state.

In step S601, the network transfer unit 401 determines whether the operating state of the print control apparatus 201 is to be changed. In the present exemplary embodiment, the operating state of the print control apparatus 201 has two types, the normal standby state and the sleep state. In other words, in step S601, the operating state of the print control apparatus 201 is determined to be changed in a case where the print control apparatus 201 is to shift to the sleep state or the print control apparatus 201 has recovered from the sleep state to the normal standby state.

In step S601, if the network transfer unit 401 determines that the operating state is not to be shifted (NO in step S601), the network transfer unit 401 repeats the processing in step S601. On the other hand, in step S601, if the network transfer unit 401 determines that the operating state is to be shifted (YES in step S601), the processing proceeds to step S602. In other words, the processing proceeds to step S602 in a case where it is determined that the print control apparatus 201 is to shift to the sleep state or the print control apparatus 201 has recovered from the sleep state to the normal standby state.

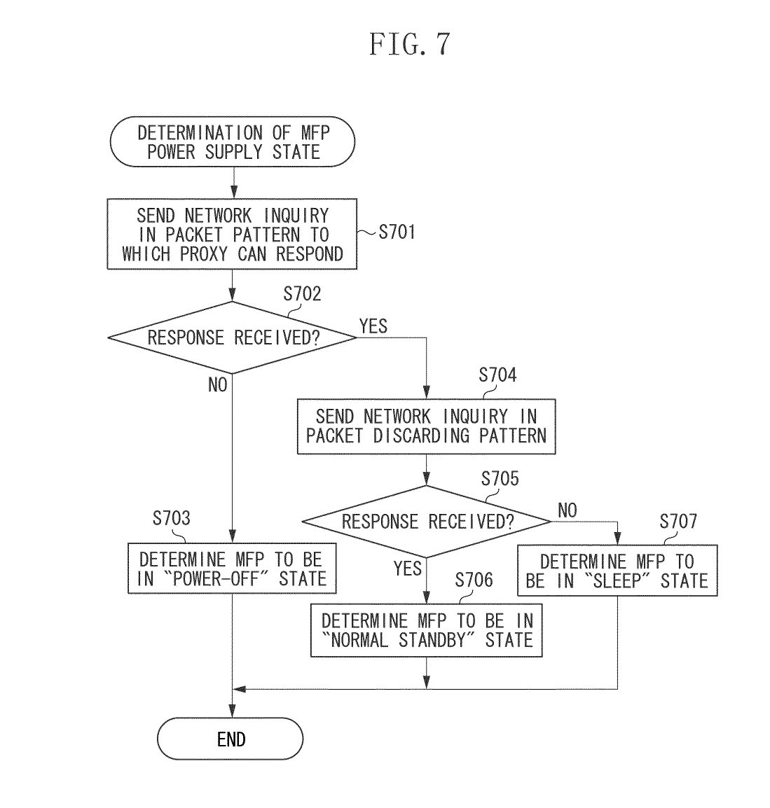

In step S602, the network transfer unit 401 determines the current operating state of the image forming apparatus 207. In the present exemplary embodiment, the network transfer unit 401 determines the operating state of the image forming apparatus 207 from the three states, the normal standby state, the sleep state, and the state in which no power is supplied. Details of the processing in step S602 will be described below with reference to FIG. 7.

In step S603, based on the result of the determination in step S602, the network transfer unit 401 determines whether the MFP is in the normal standby state. This determination is performed to determine which of the transitions T102, T108, T104, and T106 in FIG. 10 the state transition that has occurred corresponds to.

In step S603, if the network transfer unit 401 determines that the MFP is in the normal standby state (YES in step S603), the processing proceeds to step S604. In step S604, the network transfer unit 401 determines whether the change in the operating state of the DFE that is determined in step S601 is the shift of the DFE (print control apparatus 201) to the sleep state.

If the network transfer unit 401 determines that the DFE shifts to the sleep state (YES in step S604), then in step S605, the network transfer unit 401 provides a notification of the “sleep” state as the operating state of the print system over the network 212. This corresponds to the processing executed at the time of the transition T106 in FIG. 10.

On the other hand, in step S604, if the network transfer unit 401 determines that the DFE is not to shift to the sleep state (NO in step S604), the processing proceeds to step S606. In step S606, the network transfer unit 401 determines whether the change in the operating state of the DFE that is determined in step S601 is the recovery of the DFE from the sleep state to the normal standby state.

If the network transfer unit 401 determines that the DFE recovers to the normal standby state (YES in step S606), then in step S607, the network transfer unit 401 provides a notification of the “normal standby” state as the operating state of the print system over the network 212. This corresponds to the processing executed at the time of the transition T104 in FIG. 10.

On the other hand, in step S606, if the network transfer unit 401 determines that the DFE is not to recover to the normal standby state (NO in step S606), the network transfer unit 401 ends the processing illustrated in the flowchart without providing a notification of the operating state of the print system over the network 212.

To provide the notifications over the network in steps S605 and S607, the network transfer unit 401 outputs network packets from the connector 202 to the LAN 212. For example, the network transfer unit 401 uses multicast packets according to the service location protocol (SLP) to provide a notification of the operating state of the print system to a wide range of computers on the LAN 212.

The following describes the case where the determination result in step S603 is “NO.” In step S603, if the network transfer unit 401 determines that the MFP is not in the normal standby state (NO in step S603), the network transfer unit 401 ends the processing illustrated in the flowchart without providing a notification of the operating state of the print system over the network 212. That is to say, at the time of the state transitions T102 and T108 in FIG. 10, the network transfer unit 401 does not provide a notification of the operating state of the print system over the network 212. The reason is as follows.

When the change in the operating state of the DFE that is determined in step S601 is the recovery to the normal standby state, if the MFP is in the sleep state, the operating state of the print system desirably remains the “sleep” state in view of energy saving. Thus, in this case, the network transfer unit 401 does not provide a notification of the operating state of the print system over the network 212. The change in the operating state in this case corresponds to the transition T108 from the state C3 to C2.

Further, when the change in the operating state of the DFE is the shift to the sleep state, if the MFP is already in the sleep state, the operating state of the print system does not change and remains the “sleep” state. Therefore, it is not necessary to provide a notification of the operational state to a wide range of computers on the LAN 212 by use of multicast packets or the like. Thus, in this case, the network transfer unit 401 does not provide a notification of the operating state of the print system over the network 212. The change in the operating state in this case corresponds to the transition T102 from the state C2 to C3.

In view of the foregoing, in the operating state notification processing according to the present exemplary embodiment, the operating state of the print system is determined not based on the operating state of the print control apparatus 201 connected to the LAN 212 alone but based on the combination of the operating states of the print control apparatus 201 and the image forming apparatus 207, and a notification of the determined operating state is provided over the network.

In a case where the operating state is shifted from the state C1 to C2 (T101), the image forming apparatus 207 provides a notification that the operating state is shifted to the “sleep” state, and the notification is transferred over the network 212. On the other hand, in a case where the operating state is shifted from the state C3 to C2 (T108), according to the conventional notification technique that is based solely on the change in the state of the apparatus itself, the print control apparatus 201 provides a notification of the recovery to the “normal standby” state. Thus, according to the conventional techniques, although the transitions T101 and T108 are both a transition to the state C2, a notification of the “sleep” state is provided when the operating state is shifted through the path T101, whereas a notification of the “normal standby” state is provided when the operating state is shifted through the path T108. In other words, according to the conventional techniques, different notifications are sent depending on a path of the state transition although the print system shifts to the same operating state. According to the exemplary embodiment of the present invention, as described above, no notification is sent at the time of the transition T108 so that in the state C2, regardless of the path of the transition, external devices recognize that the operating state of the print system is the “sleep” state, whereby the problem can be solved that different notifications are sent depending on the path of the state transition.

Further, in a case where the print system shifts from the state C1 to C2 (T101) and then to the state C3 (T102), according to the conventional notification technique that is based solely on the change in the state of the apparatus itself, the print control apparatus 201 sends a notification that the state is shifted to the “sleep” state. In other words, according to the conventional notification technique, the image forming apparatus 207 sends a notification of the “sleep” state at the time of the transition T101, and then the print control apparatus 201 sends a notification of the “sleep” state at the time of the transition T102. This means that according to the conventional technique, the same notification may be repeated. According to the exemplary embodiment of the present invention, as described above, no notification is sent at the time of the transition T102 so that the problem of repeating the same notification can be solved.

As the foregoing describes, the network transfer unit 401 of the print control apparatus 201 operates as illustrated in FIG. 6 so that a notification of the operating state of the print system can be appropriately sent to external devices. This can solve the problem of redundantly sending the same notification from the MFP and the DFE, and also the problem of sending different notifications from the MFP and the DFE.

The following describes the processing executed by the network transfer unit 401 to determine the operating state of the image forming apparatus 207 (step S602 in FIG. 6) according to the first exemplary embodiment, with reference to FIG. 7.

FIG. 7 is a flowchart illustrating an example of the processing for determining the power supply state of the MFP (step S602 in FIG. 6) executed by the print control apparatus 201 according to the first exemplary embodiment. The CPU unit 107 loads into the second memory unit 108 a program stored in the HDD unit 105 or the like and executes the program to realize the processing illustrated in the flowchart.

In step S701, the network transfer unit 401 sends to the image forming apparatus 207 a network inquiry in a packet pattern to which a proxy can respond. The packet pattern to which a proxy can respond refers to a network inquiry to which the network response unit 404 responds if the image forming apparatus 207 is in the normal standby state and the proxy response unit 403 responds if the image forming apparatus 207 is in the sleep state. One example of the packet pattern is an Address Resolution Protocol (ARP) request packet.

In step S702, the network transfer unit 401 determines whether a response to the network inquiry sent in step S701 is received from the image forming apparatus 207. If the network transfer unit 401 determines that no response to the network inquiry sent in step S701 is received (NO in step S702), the processing proceeds to step S703. In step S703, the network transfer unit 401 determines that the image forming apparatus 207 is not activated (in the power-off state), and the processing returns to the flowchart illustrated in FIG. 6.

On the other hand, in step S702, if the network transfer unit 401 determines that a response to the network inquiry sent in step S701 is received (YES in step S702), the processing proceeds to step S704. In step S704, the network transfer unit 401 sends to the image forming apparatus 207 a network inquiry in a packet discarding pattern. The packet discarding pattern refers to a network inquiry to which the network response unit 404 responds if the image forming apparatus 207 is in the normal standby state and which is to be discarded by the proxy response unit 403 if the image forming apparatus 207 is in the sleep state. For example, the image forming apparatus 207 performs control processing in such a way that when the image forming apparatus 207 is in the sleep state, a proxy response is made to a MIB request packet that is registered in advance in the proxy response unit 403, whereas any other MIB request packet is discarded. The MIB request packet to be discarded in this processing is an example of the packet discarding pattern.

In step S705, the network transfer unit 401 determines whether a response to the network inquiry sent in step S704 is received from the image forming apparatus 207. If the network transfer unit 401 determines that a response to the network inquiry sent in step S704 is received (YES in step S705), the processing proceeds to step S706. In step S706, the network transfer unit 401 determines that the image forming apparatus 207 is in the “normal standby” state, and the processing returns to the flowchart illustrated in FIG. 6.

On the other hand, if the network transfer unit 401 determines that no response to the network inquiry sent in step S704 is received (NO in step S705), the processing proceeds to step S707. In step S707, the network transfer unit 401 determines that the image forming apparatus 207 is in the “sleep” state, and the processing returns to the flowchart illustrated in FIG. 6.

In the processing for determining the operating state of the image forming apparatus 207 described above with reference to FIG. 7, two types of network inquiries are sent to the image forming apparatus 207 in steps S701 and S704. However, neither of the inquiries does not change the operating state of the image forming apparatus 207 from the sleep state to the normal standby state, because if the image forming apparatus 207 is in the sleep state, the proxy response unit 403 responds to the inquiry sent in step S701 and discards the packets of the inquiry sent in step S704. Thus, in both cases, the operating state remains the sleep state. Accordingly, in the processing for determining the operating state of the image forming apparatus 207 which is illustrated in FIG. 7, the operating state of the image forming apparatus 207 can be determined without causing unnecessary recovery of the image forming apparatus 207 to waste power.

The processing for determining the operating state of the image forming apparatus 207 (step S602 in FIG. 6) according to an exemplary embodiment of the present invention is not limited to that illustrated in FIG. 7 according to the first exemplary embodiment. The following describes the processing for determining the operating state of the image forming apparatus 207 according to a second exemplary embodiment.

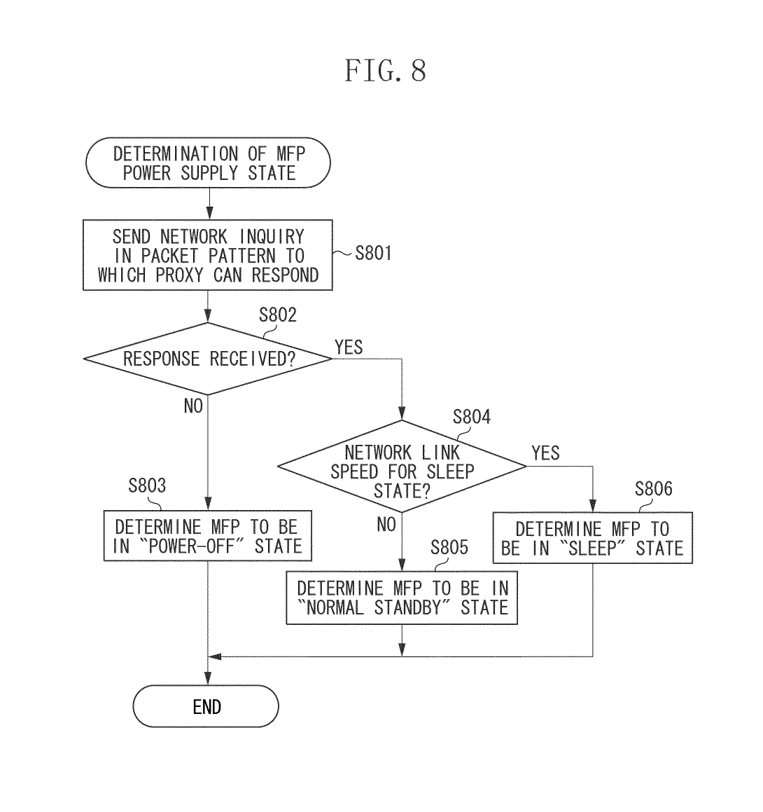

FIG. 8 is a flowchart illustrating an example of the processing for determining the power supply state of the MFP (step S602 in FIG. 6) executed by the print control apparatus 201 according to the second exemplary embodiment. The CPU unit 107 loads into the second memory unit 108 a program stored in the HDD unit 105 or the like and executes the program to realize the processing illustrated in the flowchart. The processing in steps S801, S802, and S803 are similar to that in steps S701, S702, and S703 in FIG. 7, and the description thereof is thus omitted here.

In step S802, if the network transfer unit 401 determines that a response to the network inquiry sent in step S801 is received (YES in step S802), the processing proceeds to step S804.

In step S804, the network transfer unit 401 refers to a network link speed (communication speed) between the print control apparatus 201 and the image forming apparatus 207, i.e., a network link speed between the connectors 203 and 208. Then, the network transfer unit 401 determines whether the network link speed is a network link speed used when the image forming apparatus 207 is in the sleep state. In the present exemplary embodiment, the network link speed is lower when the image forming apparatus 207 is in the sleep state than when the image forming apparatus 207 is in the normal standby state.

If the network transfer unit 401 determines that the network link speed is a network link speed used when the image forming apparatus 207 is in the sleep state (YES in step S804), the processing proceeds to step S806. In step S806, the network transfer unit 401 determines that the image forming apparatus 207 is in the “sleep” state, and the processing returns to the flowchart illustrated in FIG. 6.

On the other hand, if the network transfer unit 401 determines that the network link speed is a network link speed used when the image forming apparatus 207 is in the normal standby state (NO in step S804), the processing proceeds to step S805. In step S805, the network transfer unit 401 determines that the image forming apparatus 207 is in the “normal standby” state, and the processing returns to the flowchart illustrated in FIG. 6.

The power state of the image forming apparatus 207 can be determined using the network link speed as described above in a case where the network link speed between the connectors 203 and 208 is set to be changed when the image forming apparatus 207 shifts to the sleep state or recovers to the normal standby state.

For example, there may be a case where when the image forming apparatus 207 shifts to the sleep state, the network link speed is changed to be lower than that in the normal standby state to save energy, and when the image forming apparatus 207 recovers to the normal standby state, the network link speed is returned to the original speed, whereby the power consumption of the connector 203 is reduced. The determination processing described above with reference to FIG. 8 is effective in this case.

In the processing for determining the operating state of the image forming apparatus 207 according to the second exemplary embodiment described above with reference to FIG. 8, as in the first exemplary embodiment, the operating state of the image forming apparatus 207 is not changed from the sleep state to the normal standby state. Accordingly, in the processing for determining the operating state of the image forming apparatus 207 which is illustrated in FIG. 8, the operating state of the image forming apparatus 207 can be determined without causing unnecessary recovery of the image forming apparatus 207 to waste power.

The following describes the processing for determining the operating state of the image forming apparatus 207 according to a third exemplary embodiment.

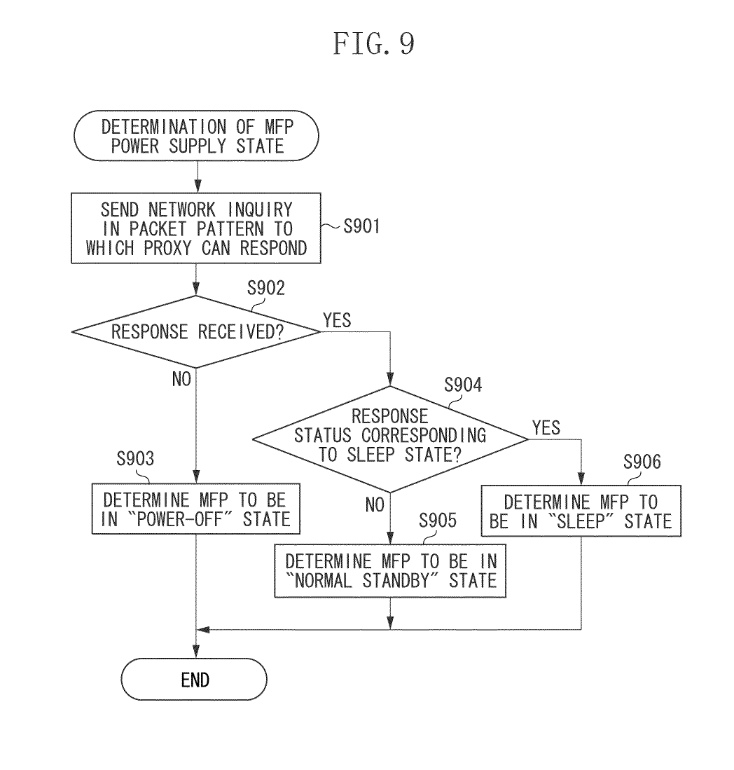

FIG. 9 is a flowchart illustrating an example of the processing for determining the power supply state of the MFP (step S602 in FIG. 6) executed by the print control apparatus 201 according to the third exemplary embodiment. The CPU unit 107 loads into the second memory unit 108 a program stored in the HDD unit 105 or the like and executes the program to realize the processing illustrated in the flowchart.

In step S901, as in step S701 in FIG. 7, the network transfer unit 401 sends to the image forming apparatus 207 a network inquiry in a packet pattern to which a proxy response can be made. The network inquiry in the present exemplary embodiment cannot be a network inquiry to which the same response content is returned in both cases where the image forming apparatus 207 is in the normal standby state and where the image forming apparatus 207 is in the sleep state as in the case of the ARP request packets. Instead, as in the case of MIB objects representing the status of the image forming apparatus 207, for example, a network inquiry is sent in such a way that the response content (response status) used when the image forming apparatus 207 is in the normal standby state is different from that used when the image forming apparatus 207 is in the sleep state.

In step S902, the network transfer unit 401 determines whether a response to the network inquiry sent in step S901 is received from the image forming apparatus 207. If the network transfer unit 401 determines that no response to the network inquiry sent in step S901 is received from the image forming apparatus 207 (NO in step S902), the processing proceeds to step S903. In step S903, the network transfer unit 401 executes processing similar to that in step S703 in FIG. 7.

On the other hand, if the network transfer unit 401 determines that a response to the network inquiry sent in step S901 is received from the image forming apparatus 207 (YES in step S902), the processing proceeds to step S904. In step S904, the network transfer unit 401 interprets the content of the response received in step S902 and determines whether the content of the response (response status) corresponds to the sleep state of the image forming apparatus 207.

If the network transfer unit 401 determines that the content of the response received in step S902 corresponds to the sleep state of the image forming apparatus 207 (YES in step S904), the processing proceeds to step S906. In step S906, the network transfer unit 401 determines that the image forming apparatus 207 is in the “sleep” state, and the processing returns to the flowchart illustrated in FIG. 6.

On the other hand, if the network transfer unit 401 determines that the content of the response received in step S902 corresponds to the normal standby state of the image forming apparatus 207 (NO in step S904), the processing proceeds to step S905. In step S905, the network transfer unit 401 determines that the image forming apparatus 207 is in the “normal standby” state, and the processing returns to the flowchart illustrated in FIG. 6.

The foregoing determination can be performed in a case where packet patterns having different response contents depending on whether the image forming apparatus 207 is in the normal standby state and whether the image forming apparatus 207 is in the sleep state are registered in advance in the proxy response unit 403, as in the case of the above-mentioned MIB objects representing the status.

In the processing for determining the operating state of the image forming apparatus 207 according to the third exemplary embodiment described above with reference to FIG. 9, as in the first and second exemplary embodiments, the operating state of the image forming apparatus 207 is not changed from the sleep state to the normal standby state. Accordingly, in the processing for determining the operating state of the image forming apparatus 207 which is illustrated in FIG. 9, the operating state of the image forming apparatus 207 can be determined without causing unnecessary recovery of the image forming apparatus 207 to waste power.

As described above, according to each of the exemplary embodiments of the present invention, a notification of the operating state of the print system can be sent to a computer on the network based on not only a change in the operating state of the print control apparatus 201 but also the operating state of the image forming apparatus 207. In this way, the exemplary embodiments of the present invention can solve the conventional problem of redundantly sending the same notification from the MFP and the DFE and also the conventional problem of sending different notifications depending on the path of the state transition although the print system shifts to the same operating state. Furthermore, at the point when the operating state of the print control apparatus 201 is changed, the operating state of the image forming apparatus 207 can be accurately determined, and a notification of the state of the print system can be sent to an external device. Therefore, according to the exemplary embodiments of the present invention, a notification of the operating state of the print system can be sent more desirably in view of energy saving and the like. That is to say, a notification of the operating state of the print system can be appropriate sent.

Further, in any of the processing for determining the operating state of the image forming apparatus 207 according to the first, second, and third exemplary embodiments described above with reference to FIGS. 7, 8, and 9, unnecessary recovery of the image forming apparatus 207 to the normal standby state is avoided. Thus, the print control apparatus 201 can accurately determine the operating state of the image forming apparatus 207 without causing unnecessary recovery of the image forming apparatus 207. Accordingly, a change in the operating state of the print control apparatus 201 does not cause unnecessary recovery of the image forming apparatus 207 to the normal standby state so that the sleep state of the image forming apparatus 207 can be maintained longer, whereby the power consumption can be reduced.

In the first to third exemplary embodiments, the packet pattern to which a proxy response can be made, the inquiry packet pattern that requires the recovery to the normal standby state, the packet pattern to be discarded, and the like are registered in the proxy response unit 403 of the image forming apparatus 207. Based on the packet patterns, the proxy response unit 403 executes processing to recover the image forming apparatus 207 to the normal standby state, make a proxy response, or discard the packets.

In the flowchart illustrated in FIG. 5, the proxy response unit 403 is controlled in such a way that when a packet that does not belong to any of the above packet patterns is received, the proxy response unit 403 discards the received packet. Alternatively, the proxy response unit 403 may be controlled in such a way that when a packet that does not belong to any of the above packet patterns is received, the proxy response unit 403 recovers the image forming apparatus 207 to the normal standby state to process the received packet.

According to a fourth exemplary embodiment, the image forming apparatus 207 is configured to be operable by switching between in at least two response modes (first and second modes).

The first mode is a response mode in which when the image forming apparatus 207 in the sleep state receives a packet that does not belong to any of the above packet patterns, the image forming apparatus 207 recovers to the normal standby state to process the packet.

The second mode is a response mode in which when the image forming apparatus 207 in the sleep state receives a packet that does not belong to any of the above packet patterns, the image forming apparatus 207 discards the packet.

The user selects and sets the first or second mode in advance as the response mode and registers the response mode in advance in the proxy response unit 403 by use of the operating unit 302 or the like. The setting of the response mode is stored in, for example, the flash ROM 308b. When the proxy response unit 403 in the sleep state receives a packet that does not belong to any of the above packet patterns, the proxy response unit 403 executes the following control processing.

In a case where the first mode is set, the proxy response unit 403 executes the control processing in such a way that the image forming apparatus 207 recovers to the normal standby state to process the packet, as illustrated in steps S505 and S506 in FIG. 5. On the other hand, in a case where the second mode is set, the proxy response unit 403 executes the control processing to discard the packet as illustrated in step S507 in FIG. 5.

As the foregoing describes, the user selects and sets the response mode to cause the image forming apparatus 207 to operate as desired by the user. For example, the packet processing is prioritized in the first mode, or a saving in power consumption is prioritized in the second mode.

Further, the above-described response modes of the image forming apparatus 207 may be applied to the print control apparatus 201 in a similar way. This will be specifically described as follows.

The inquiry packet pattern that requires the recovery to the normal standby state, the packet pattern to be discarded, and the like are registered in the network transfer unit 401 of the print control apparatus 201. Based on the registered packet patterns, the NIC units 101 and 104 execute the normal standby state recovery processing, the packet discarding processing, etc. Further, the response mode in which the image forming apparatus 207 recovers to the normal standby state to process the packet (first mode) and the response mode in which the packet is discarded (second mode) in a case where a packet that does not belong to any of the above packet patterns is received can be switched by the user setting.

The user selects and sets the first or second mode in advance as the response mode and registers the response mode in advance in the network transfer unit 401 by use of the operating unit 109 or the like. In a case where the network transfer unit 401 in the sleep state receives a packet that does not belong to any of the above packet patterns, the network transfer unit 401 executes the following control processing. In a case where the first mode is set, the network transfer unit 401 executes the control processing in such a way that the print control apparatus 201 recovers to the normal standby state to process the packet. On the other hand, in a case where the second mode is set, the network transfer unit 401 executes the control processing to discard the packet. In a case where the network transfer unit 401 is configured not to function in the sleep state, the NIC units 101 and 104 are configured to execute the foregoing control processing.

As the foregoing describes, the user selects and sets the response mode of the print control apparatus 201 so that the print control apparatus 201 operates as desired by the user. For example, the packet processing is prioritized in the first mode, or a saving in power consumption is prioritized in the second mode.

The configurations and contents of the various types of data described above are limited to those described above, and may vary according to the use and purpose.

The above-described exemplary embodiments of the present invention are applicable to, for example, a system, an apparatus, a method, a storage medium, etc. More specifically, the exemplary embodiments are applicable to a system consisting of multiple devices or an apparatus consisting of a single device.

Further, any combination of the foregoing exemplary embodiments is also encompassed within the scope of the present invention.

As described above, the print systems including the MFP and the DFE connected to each other according to the exemplary embodiments of the present invention produce the following advantages.

For example, the operating state of the print system is determined based on not the operating state of one of the MFP and the DFE but the combination of the operating states of the MFP and the DFE, and a notification of the determined operating state is sent over the network, whereby a notification of the operating state can be sent more desirably in view of energy saving and the like.

Furthermore, the operating state of the MFP can be accurately determined at the point of sending a notification over the network without changing the operating state. Thus, recovery of the MFP to the normal standby state that is not desired by the user does not occur so that the power consumption can be reduced.

The exemplary embodiments of the present invention may also be realized by executing the processing in which software (program) that realizes the functions of the exemplary embodiments described above is provided to a system or an apparatus via a network or various storage media, and a computer (or CPU, micro-processing unit (MPU), etc.) of the system or the apparatus reads and executes the program.

Further, the exemplary embodiments of the present invention are applicable to a system consisting of multiple devices and an apparatus consisting of a single device.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

According to the exemplary embodiments of the present invention, a notification of the operating state of a print system in which a print control apparatus and an image forming apparatus are connected to each other can be appropriately sent in view of energy saving.

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD™), a flash memory device, a memory card, and the like.

This application claims the benefit of Japanese Patent Application No. 2013-246934 filed Nov. 29, 2013, which is hereby incorporated by reference herein in its entirety.

What is claimed is:

1. A print control apparatus in a print system including the print control apparatus and an image forming apparatus, wherein the print control apparatus is connected to a network and operates by switching between at least a first operating state and a second operating state lower in power consumption than the first operating state, and the image forming apparatus is connected to the print control apparatus and operates by switching between at least a third operating state and a fourth operating state lower in power consumption than the third operating state, the print control apparatus comprising a notification unit configured to determine a power state of the print system based on an operating state of the print control apparatus and an operating state of the image forming apparatus, and then send a notification of the determined power state over the network,
wherein in a case where there is a change in the operating state of the print control apparatus, the notification unit determines the operating state of the image forming apparatus, determines the power state of the print system based on the change in the operating state of the print control apparatus and the determined operating state of the image forming apparatus, and then sends a notification of the determined power state over the network.

2. The print control apparatus according to claim 1, wherein in a case where the notification unit determines that the image forming apparatus is in the third operating state, the notification unit determines the power state of the print system based on the change in the operating state of the print control apparatus, and then sends a notification of the determined power state.

3. The print control apparatus according to claim 1, wherein in a case where the notification unit determines that the image forming apparatus is not in the third operating state, the notification unit sends no notification of the power state of the print system.

4. The print control apparatus according to claim 1, wherein the notification unit sends to the image forming apparatus an inquiry to which the image forming apparatus responds in the third operating state but does not respond in the fourth operating state, and in a case where the image forming apparatus responds to the inquiry, the notification unit determines that the image forming apparatus is in the third operating state, and in a case where the image forming apparatus does not respond to the inquiry, the notification unit determines that the image forming apparatus is in the fourth operating state.

5. The print control apparatus according to claim 1, wherein the notification unit sends to the image forming apparatus an inquiry to which the image forming apparatus responds without changing the operating state, and the notification unit determines the operating state of the image forming apparatus based on a communication speed between the image forming apparatus and the print control apparatus that is used when the image forming apparatus responds to the inquiry.

6. The print control apparatus according to claim 1, wherein the notification unit sends to the image forming apparatus an inquiry to which the image forming apparatus sends a response without changing the operating state, the response having a content that varies depending on the operating state of the image forming apparatus, and the notification unit determines the operating state of the image forming apparatus based on the content of the response from the image forming apparatus.

7. The print control apparatus according to claim 4, wherein the notification unit sends to the image forming apparatus an inquiry to which the image forming apparatus responds in the third operating state or the fourth operating state without changing the operating state, and in a case where the image forming apparatus does not respond to the inquiry, the notification unit determines that the image forming apparatus is in a power-off state.

8. The print control apparatus according to claim 1, wherein in a case where the notification unit receives from the image forming apparatus a notification of the operating state of the image forming apparatus that is sent from the image forming apparatus when the operating state of the image forming apparatus is changed while the print control apparatus is in the first operating state, the notification unit determines the power state of the print system based on the operating state of the image forming apparatus in the received notification, and then sends a notification of the determined power state over the network.

9. The print control apparatus according to claim 1, wherein in a case where the notification unit receives from the image forming apparatus a notification of the operating state of the image forming apparatus that is sent from the image forming apparatus when the operating state of the image forming apparatus is changed while the print control apparatus is in the second operating state, the notification unit sends no notification of the power state of the print system over the network.

10. A method for controlling a print control apparatus in a print system including the print control apparatus and an image forming apparatus, wherein the print control apparatus is connected to a network and operates by switching between at least a first operating state and a second operating state lower in power consumption than the first operating state, and the image forming apparatus is connected to the print control apparatus and operates by switching between at least a third operating state and a fourth operating state lower in power consumption than the third operating state, the method comprising determining a power state of the print system based on an operating state of the print control apparatus and an operating state of the image forming apparatus, and then sending a notification of the determined power state over the network,
wherein in a case where there is a change in the operating state of the print control apparatus, the operating state of the image forming apparatus is determined, the power state of the print system is determined based on the change in the operating state of the print control apparatus and the determined operating state of the image forming apparatus, and then a notification of the determined power state is sent over the network.

11. A computer-readable storage medium storing a program for causing a computer to function as the print control apparatus according to claim 1.
